(19) United States
(12) Patent Application Publication
(10) Pub. No.: US 2010/0293206 A1
(43) Pub. Date: Nov. 18, 2010

(54) Clustering related objects during garbage collection

(75) Inventor: Tatu J. Ylonen, Espoo (FI)

Correspondence Address: TATU YLONEN OY, LTD., KUTOJANTIE 3, ESPOO, 02630, FI

(73) Assignee: TATU YLONEN OY LTD, Espoo (FI)

(21) Appl. No.: 12/464,231

(22) Filed: May 12, 2009

(51) Int. Cl. G06F 12/02; G06F 12/00; G06F 17/30; G06F 7/00

(52) U.S. Cl. 707/813; 707/796; 707/959; 707/955; 711/2; 711/3

(57) ABSTRACT

Clustering related objects in a region-based garbage collector is solved by associating one or more regions with each cluster, and allocating objects from a region belonging to the primary cluster for the object. Relatedness may refer to, e.g., proximity to a cluster center (such as topic) in a persistent knowledge base or a home node in a distributed object system. The cluster for an object may be determined, e.g., from reachability from particular roots or objects during global tracing. For new objects, the initial cluster may be guessed based on history of where objects allocated in that call site have recently been clustered (possibly several stack frames deep).

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

This invention relates to garbage collection as an automatic memory management method in computer systems. It also relates to object clustering in distributed object systems and persistent object stores and databases.

### BACKGROUND OF THE INVENTION

An extensive survey of various garbage collection technologies is provided in R. Jones and R. Lins: Garbage Collection: Algorithms for Dynamic Memory Management, Wiley, 1996.

P. Bishop: Computer Systems with a Very Large Address Space and Garbage Collection, MIT/LCS/TR-178, MIT, 1977 (NTIS ADA040601) describes the use of multiple independently collectable areas (called regions in modern terminology) and the use of a measure called gc_index as the priority of garbage collecting a particular region.

D. Detlefs et al: Garbage-First Garbage Collection, ISMM'04, ACM, 2004, pp. 37-48, which is hereby incorporated herein by reference, describes a modern soft-realtime incremental region-based garbage collector that also supports generations. It also describes snapshot-at-the-beginning global tracing.

Pizlo et al: STOPLESS: A Real-Time Garbage Collector for Multiprocessors, ISMM'07, ACM, 2007, pp. 159-172 describes a modern real-time garbage collector.

U.S. Pat. No. 6,826,583, which is hereby incorporated herein by reference, describes thread-local allocation buffers.

U.S. Ser. No. 12/436,821, which is hereby incorporated herein by reference, describes grouped allocation of objects from one or more memory regions.

U.S. Ser. No. 12/147,419, which is hereby incorporated herein by reference, describes garbage collection using multiobjects and related memory management operations, including the global transitive closure computation. The definition of a multiobject was relaxed in U.S. Ser. No. 12/432,779, which is hereby incorporated herein by reference.

U.S. Pat. No. 7,428,560, which is hereby incorporated herein by reference, describes segregating objects into regions based on their age. Their system assigns age values to regions without recording ages separately for all dynamically allocated objects.

In very large object systems, such as large knowledge bases, the knowledge base may grow much larger than the physical memory in a computer. In such cases, e.g. virtual memory and/or a disk-based persistent storage system may be used to contain much of the data. A key problem in both kinds of systems is clustering data such that a subset of all regions in the system would contain the relevant data for a particular topic. Then, only those regions containing information about the current topic (and general information common to all topics) would need to be in main memory most of the time.

Another problem in such systems is achieving reasonable start-up times. Clustering the relevant information is critical for fast loading; if every object must be loaded separately from disk, loading the data could take a very long time (hours, days, or even more in a large system).

Proper clustering can speed up virtual memory, disk-based storage, and loading data from disk by several orders of magnitude. It is thus desirable to be able to cluster related objects into the same region.

### BRIEF SUMMARY OF THE INVENTION

Related objects are clustered during garbage collection into regions preferably containing only objects belonging to the same cluster by using multiple regions for allocating copied objects and selecting the region from which a particular object is allocated based on its association with various clusters.

Objects may be related in a number of ways. A number of embodiments where objects are tagged with cluster tags, as well as a number of embodiments where objects are associated with the “nearest” cluster using a relatedness metric, are described.

The clustering takes place during garbage collection time, when objects are copied anyway.

### BRIEF DESCRIPTION OF THE SEVERAL VIEWS OF THE DRAWING(S)

FIG. 1 illustrates a computer according to an embodiment of the invention.

FIG. 2 illustrates associating an object with a cluster and allocating space for the object from a region associated with the cluster.

FIG. 3 illustrates caching allocation information associated with a cluster.

FIG. 4 illustrates associating one or more tags with a cluster using a relatedness metric.

### DETAILED DESCRIPTION OF THE INVENTION

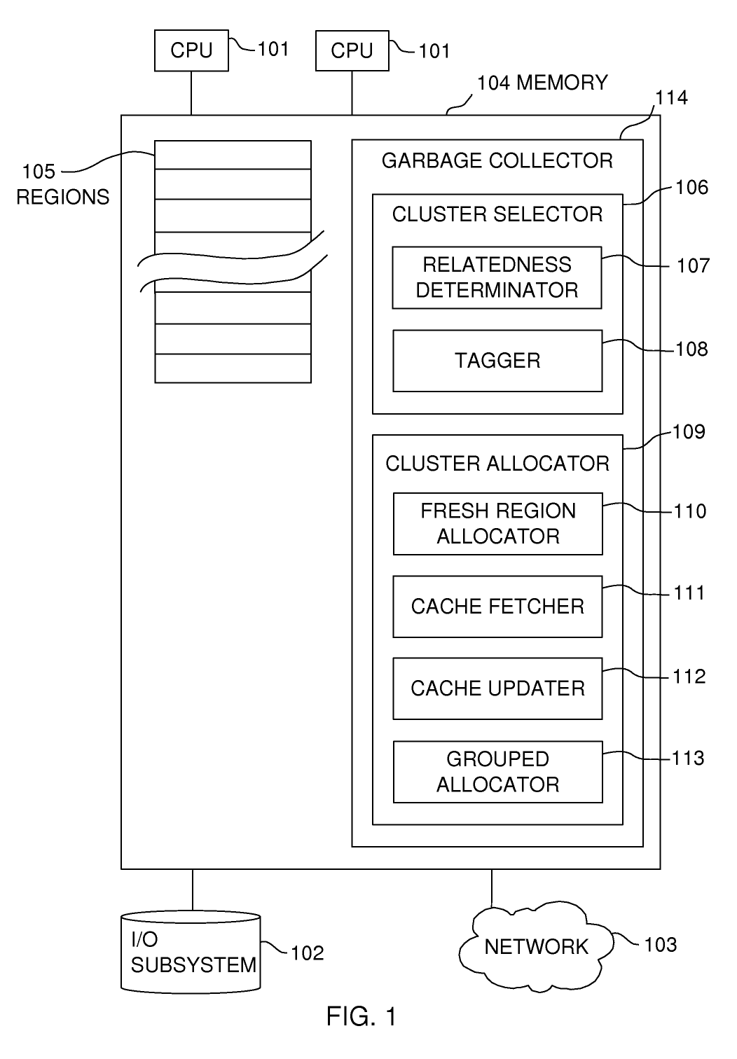

FIG. 1 illustrates a computer according to a possible embodiment of the invention. (101) illustrates one or more processors, (102) illustrates an I/O subsystem (typically including a computer-readable non-volatile storage medium such as magnetic or optical disk, or flash memory), (103) illustrates a data communications network such as the Internet or a telecommunications network (possibly wireless), that may be used to communicate with other computers, users, networked storage, etc, (104) illustrates the memory space of the computer (typically comprising one or more semiconductor memory chips in current computers).

(105) illustrates a plurality of memory regions. At least some of the memory regions are garbage collectable without garbage collecting some other region(s). In some embodiments at least some regions may be tagged with cluster tags, which may be stored in a region header data structure.

(114) illustrates a garbage collector that comprises a means for clustering related objects. In many embodiments clustering would be performed during garbage collection (often without adding any extra copying, by just influencing where copied objects are allocated). However, in some embodiments (e.g., some embodiments using multiobjects) objects may be relocated at any time or at least partly in parallel with mutator execution, and in such embodiments clustering could be performed also at other times. Also, real time garbage collectors, such as the STOPLESS collector, only pause mutators for very short synchronization pauses. For the purposes of this disclosure and the claims, the related object clustering means described herein will be considered part of the garbage collector and clustering will be considered being performed by the garbage collector even if it is performed partly or wholly in parallel with mutators, as long as it accesses the garbage collector's data structures and synchronization mechanisms and/or shares many of its elements or operations, and generally operates on the same level in the system as the garbage collector.

(106) illustrates the cluster selector, a component that associates an object with one or more clusters. It basically decides which cluster(s) the object belongs to. In most embodiments it is expected to be part of the garbage collector, but in some embodiments at least part of the cluster selection could be advantageously performed by a separate background process technically running as a mutator. Such a background process could, e.g., analyze a knowledge base when the system is otherwise idle, and mark objects with cluster tags (probably using a suitable API provided by the garbage collector) or modify the knowledge base by adding suitable links between clusters and objects that should be added to the clusters. Even in such cases there would be at least a trivial cluster selector in the garbage collector (at least one retrieving the marked cluster for the object); in many cases the markings made by the application-level cluster selector would be treated as a measure or bias by the garbage collector level cluster selector.

There may be any number of clusters, and clusters may be added, merged, or removed at any time in some embodiments.

The system will preferably try to allocate objects associated with the same cluster from the same region. However, several clusters may be placed in the same region (especially if the clusters are very small), and a cluster may span any number of regions (large clusters may be many times larger than the region size). Also, in some embodiments an object may be associated with more than one cluster. Thus, the clustering may not always be accurate. In some embodiments some of the clusters may be combined into an “everything else” category; for example, a system might actually cluster the first N most important clusters, and put all other objects into a final category “everything else” (the final category essentially treated like a single cluster).

In many embodiments, cluster tags will be used to represent cluster memberships for an object (and/or region). A cluster tag is preferably a relatively small integer; however, it could also be, e.g., a string, a pointer to an object, or a pointer to a special cluster descriptor. Pointers to prototype members of clusters could also be used as cluster tags in some embodiments. The component that assigns tags to objects is illustrated by the tagger (108).

In some embodiments an object may be associated with more than one cluster. Preferably the object is then tagged with one or more cluster tags. A number of alternatives are available for interpreting multiple tags.

One option is to select a primary tag from among the tags, either by picking an arbitrary one (such as the first in a list), or using information to impose an order among the tags (the order could be a full order or a partial order). The “highest” one according to the order could then be selected (or one of the highest, arbitrarily or using additional information, if the order is a partial order). An example of such an order is ranking clusters by some usefulness metric, such as how well membership in the cluster predicts that other objects in the cluster will be used shortly after accessing one object from the cluster. Many other orders could also be used. Only the primary tag would then be used for selecting the cluster.

Another option is to use the set of tags associated with the object to indicate its cluster collectively. For example, one could use a hash table or other index keyed by the set of tags (any known method for keying a hash table with a set could be used, such as sorting the set into a list in a canonical order, creating a bit vector with bits corresponding to the tags set, and using it to key the hash table, or using a hash function to compute a multi-bit pseudo-random (but deterministic) signature for each tag, and combine the tags using bitwise “or” to produce a set signature for use as a key). Effectively, the set of clusters is then the powerset (set of all subsets) of the set of tags.

A third option is to consider the tags associated with the object as indices for a fixed set of dimensions. For example, one dimension could be a quantized age of the object, and another dimension could be the class of the object. With this approach, only one tag for each dimension should be added, and different dimensions could use overlapping tag values. The set of clusters could then correspond to the cross product of the possible values for each dimension. (With this approach, the cache described below would conveniently be a multi-dimensional array or a multi-key hashtable.)

Other ways of interpreting multiple tags are also possible, including various combinations of the above.

It should be understood that cluster tags are only one convenient possibility for implementing the cluster selection; it is also possible to select the appropriate cluster directly without using tags.

One option is to use a number of metrics (some potentially discrete, some continuous) and use any known vector quantization algorithm (including but not limited to Kohonen's LVQ algorithm and other supervised and unsupervised vector classification/clustering algorithms). The quantized value may be used directly as a cluster identifier (or tag), or may be mapped to a tag using any suitable mapping means (including but not limited to using a hash table, array, or arithmetic expression). Such mapping can in some embodiments also be implemented before quantization, and in other embodiments (especially those employing supervised clustering), the quantization may directly produce cluster identifiers or tags.

Another option is to compute a relatedness metric between the object being classified and one or more candidate clusters. The relatedness metric would measure the degree of association of the object with the cluster, preferably with higher values indicating higher degree of association. The object could then be associated with the cluster with which it had the highest relatedness metric of those computed (it may not be practical to compute the metric with all clusters for performance reasons). The relatedness metric is related to known nearest neighbor search and k-means clustering using a suitable dimension metric (not necessarily Euclidean). The component that performs these computations is illustrated by (107).

Both quantization methods and relatedness metric methods are likely to be approximate. However, a major reason for clustering related objects into the same regions is to statistically improve performance, and thus it is not critical if some individual objects or relatively rarely used objects are misclassified.

Both quantization and relatedness metric methods can use any number of individual measures in the computation. Some of the measures may be parameters of the region (e.g., in a distributed persistent object system the node number(s) where the region is persistently stored on disk). Others may be computable from the object itself (such as its class, as understood, e.g., in the Java programming language).

Some measures may require a global reachability analysis to compute. Region-based garbage collectors typically perform some kind of global reachability analysis anyway in order to detect garbage cycles spanning multiple regions (the train algorithm being an exception where such garbage cycles are eliminated differently).

It may be advantageous to compute some measures during global tracing (e.g., snapshot-at-the-beginning tracing or incremental-update tracing as are known in the art), or during the global transitive closure computation in multiobject-based garbage collection. The traversal process used in such computations can be adapted to determine or estimate, for each object or multiobject, the nearest root(s) and/or cluster head(s) from which the object or multiobject can be reached by following pointers in the object graph. It can also compute or estimate the distance (or proximity) to the nearest root or cluster head. The distance (or proximity) can be measured, e.g., as the number of pointers that had to be followed to reach the object (or the number of multiobjects through which the traversal had to pass). In some cases it may be desirable to assign different weights to different pointers for such calculation (e.g., depending on the class of each object on the path and the field containing the pointer in each case).

In many cases measures computed during global tracing might be only approximate due to performance reasons. Also, it may not be desirable to store the value of the measure at every object, as that would cause prohibitive space overhead. In the case of multiobject-based garbage collection, it would be possible to store the measures in the multiobject headers of at least some multiobjects.

Another possibility is to store the information only for pointers across regions (remembered sets of some kind are typically used for storing information about and/or locating such pointers, as is known in the art). One could store the measures computed during traversing in the remembered sets while traversing. When collecting a particular region, one could use the information stored in the remembered sets by the last global tracing or transitive closure computation as the estimate of the value of the measure at the entry point to the region. The estimate for an object within the region could then be, e.g., the value in the remembered set entry from which the object was reached, or could be computed in a more sophisticated manner from the remembered set entries, taking into account that an object may be reachable from multiple remembered set entries (preferably taking into account the nearest or otherwise dominant one, and adjusting distances, etc, according to the distance within the region to the remembered set entry).

A cluster head can mean an object identifying the cluster. In some embodiments a cluster may be identified by one or more prototype members or a cluster center, in which case the cluster head can mean any of these.

Measures that can be used in computing tags, as inputs to the expression that is quantized, for computing relatedness metrics, or otherwise for selecting the cluster(s) include but are not limited to:
the object's proximity to a cluster head
the object's reachability from garbage collection roots
the return addresses contained in the call stack when the object was created
the frequency of use of the object
the home node of the object in a distributed system
the persistence of the object
the frequency of writes to the object
the frequency of object graph modifying writes to the object (i.e., pointer field writes)
the class of the object
the clusters associated with objects that reference the object
the age of the object as measured in bytes allocated since the object was created
the age of the object as measured in the number of times the object has been promoted, and
the age of the object as measured in wall clock time (i.e., real time in seconds, minutes, etc).

(109) illustrates a cluster allocator. Its task is to allocate space for an object from the selected cluster. It may perform the allocation one object at a time, or in some embodiments, several objects at a time. Depending on the embodiment, objects or multiobjects may be constructed or copied into the allocated space immediately after allocation, or somewhat later. In embodiments that group multiple objects and allocate space for them in one operation, both allocation and construction/copying can be substantially delayed from associating a cluster with the objects.

In many embodiments the allocator first selects a region (or some other information identifying a region or a section of memory within a region, such as a thread-local allocation buffer). In other embodiments it may collect several objects into a group, and then select one or more regions for allocating them at the time space is allocated for the objects in the group.

Selecting the region may be done, e.g., by having a global array or index data structure mapping tags or tag sets to regions. The data structure used for the selection may be thread-local, global, or a mix of the two (e.g., most frequently used tag sets fetched thread-locally, and others reverting to a global data structure that uses locking or atomic operations).

The components of the cluster allocator may include the fresh region allocator (110), which adds a new region (usually an empty one) to be used for allocating objects from a particular cluster, the cache fetcher (111), which tries to obtain cached allocation information (such as a region, region identifier, a thread-local allocation buffer, or a group), the cache updater (112), which updates the cached allocation information in the cache to reflect that an object has been, e.g., added to the group or allocated, or adds new allocation information to the cache (e.g., after allocating a fresh region), and the grouped allocator (113), which would typically be present in embodiments utilizing grouped allocation, and would allocate space for all objects in the group from one or more regions (typically a contiguous memory area from a single region).

Allocating from the selected region may be done, e.g., using a NEW pointer (pointer to next available address, which is incremented or decremented by the object size when an object is allocated; if multiple threads can allocate using the same pointer then it must be synchronized using locks or atomic operations). This approach is usable even without an allocation information cache, though preferably at least the region currently being used for allocation would be cached for at least some clusters to speed up allocation.

Thread-local allocation buffers are by definition thread-local. In such cases, the cache containing allocation information would preferably be local to each garbage collection thread, though it is also possible to construct embodiments where allocation information (e.g., LABs) are cached for some clusters, whereas other clusters are allocated using global information. The cached allocation information might be just the LAB, in which case it might not necessarily contain an explicit reference to the region from which the allocation is taking place. However, it would implicitly reference the region, as the memory address range from which space is allocated using the LAB would be within the region's boundaries.

Caching the allocation information can provide major speedups. However, it introduces the problem that a region might be selected for collection/compaction (included in a collection set) while cached allocation information referencing the region exists. This could easily lead to data corruption or inefficient allocation.

A possible solution to this problem is removing all cached allocation information referencing the selected region when the region is added to the collection set. This is an example of compensating actions taken in response to the region becoming selected for collection. This solution can be quite feasible when the collection set is constructed by just one thread, without allocations occurring in parallel. However, if allocations are occurring in parallel, this is likely to require concurrency control operations whose overhead may be non-trivial (especially for the allocator). Without the concurrency control concerns, one could implement the removing fairly easily, e.g., by iterating over the cached allocation information items, checking which region they refer to, and removing ones that refer to the added region, or by using a hash table or other suitable data structure to quickly find the relevant ones, or by having a list of referencing allocation information items in each region.

A second possible solution is to prevent selecting regions that are currently being used for allocation (that have cached allocation information referencing them). This approach avoids the concurrency control issues if there are allocations going on in parallel, and also avoids having to iterate over the cache or maintain an auxiliary index or list data structure. This second solution could be implemented by having a flag or counter in the region header indicating that it is (or how many times it is) referenced by allocation information. If a priority queue is used for selecting regions for the collection set, a region could be removed from the priority queue either when the first allocation information reference is added to it or when an attempt is made to select the region and it is found to have allocation information references based on such counter or flag (delaying the removal could help reduce overhead). The region could be added back to the priority queue when the flag is cleared or counter becomes zero (assuming it had been removed in the first place, which could be indicated by a flag in the region header).

Grouped allocation (U.S. Ser. No. 12/436,821) can provide significant advantages over LAB-based allocation in embodiments where the number of clusters can be high. It may also eliminate the need for removing allocation information from the cache when the region is included in a collection set, or preventing its inclusion in a collection set. (A collection set refers to the set of regions to be evacuated during a particular evacuation pause; the set may be selected at the beginning of the evacuation pause, and/or regions may be added to it after evacuating some other regions, e.g., until the desired evacuation pause duration has been reached.)

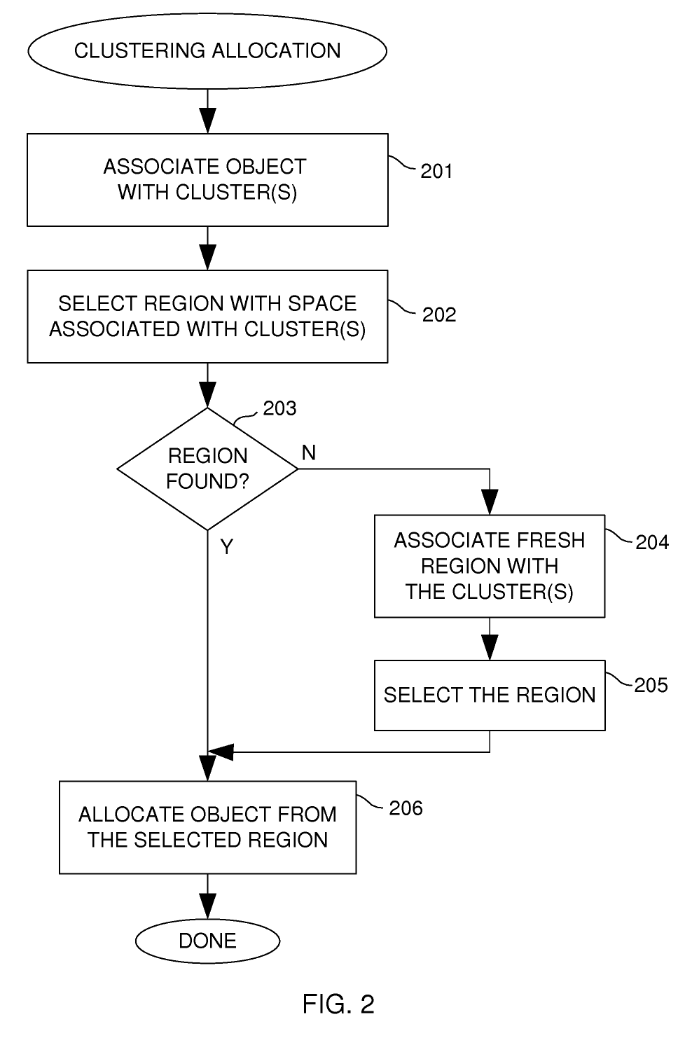

The operations performed by the various components are illustrated in FIGS. 2, 3, and 4. These also illustrate the method aspect of the invention.

FIG. 2 illustrates clustering allocation that clusters related objects during garbage collection. The steps in FIG. 2 illustrate an embodiment of allocating space for an object to be copied. Typically the object would be copied to the allocated space shortly thereafter.

Step (201) illustrates associating an object with one or more clusters, whether using cluster tags, relatedness metric, quantization, or otherwise. Various possibilities for implementing this step were already discussed above.

Step (202) selects a region associated with the cluster(s) associated with the object and with available space. Selecting the region could mean using the same region that was previously used for the cluster, or using a suitable data structure to locate an existing region already belonging to the same cluster that has space for the new object. It could also cache the most recently used region for this cluster or other allocation information, such as a thread-local allocation buffer or a group for grouped allocation, as discussed elsewhere in this specification.

Step (203) checks if a region with enough space was found. If not, then execution continues to (204) to associate a fresh region with the cluster(s). In many embodiments it would allocate a new empty region from a freelist (or by allocating more memory), and make it the selected region for the cluster in (205).

Step (206) allocates an object from the selected region (or causes one to be allocated). If a thread-local allocation buffer is used, then the object can be allocated from the LAB without locking; if a region-level NEW pointer is used, then in multiprocessor environments some kind of atomic operations might need to be used if multiple threads can allocate from the same region simultaneously. With grouped allocation, the object might be added to a group for later allocation.

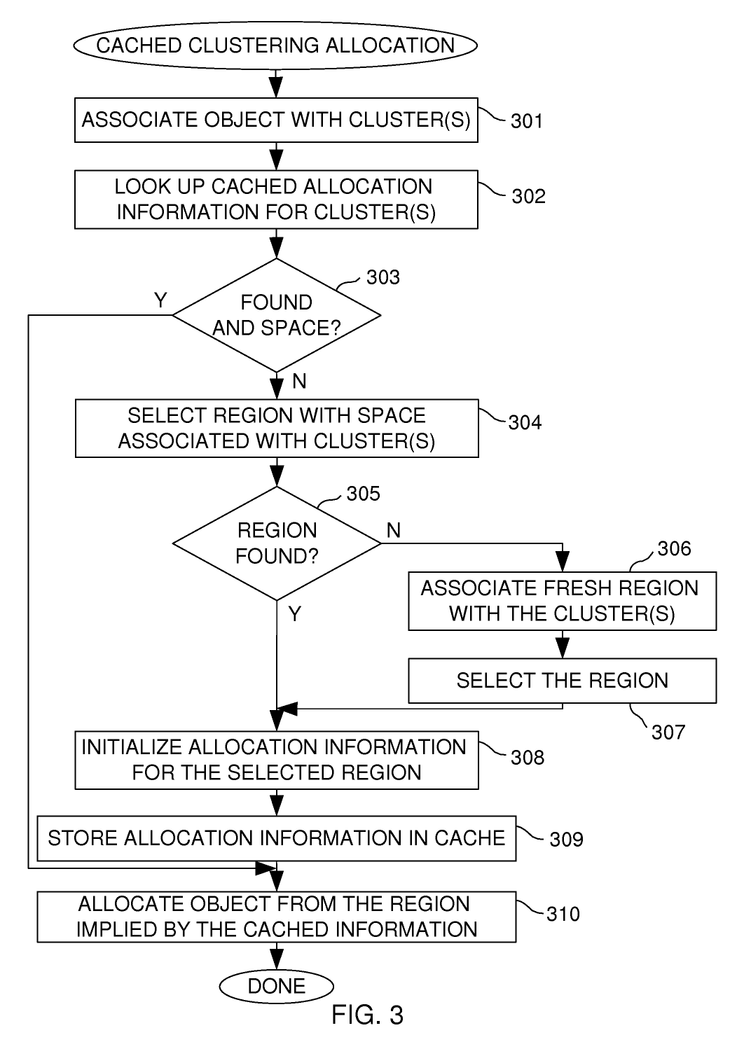

FIG. 3 illustrates cached clustering allocation, i.e., allocation when allocation information for a cluster is cached. The cache itself could be, e.g., data stored in a cluster descriptor, an array indexed by one or more cluster tags, or a hash table or other index data structure keyed by one or more cluster tags. The cache could be thread-local, global, or a mix of the two.

In some embodiments, the cache is global but is arranged such that in the common case it can be accessed without any locking or other atomic operations. Preferably atomic instructions would only be needed when updating the cached information. Any known method of implementing such cache could be used.

Step (301) illustrates associating an object with one or more clusters, whether using cluster tags, relatedness metric, quantization, or otherwise.

Step (302) looks up cached allocation information from the cache. If the cache is global (shared by more than one thread), then this may need to use locking or atomic instructions (in fact, the lock might be held until, e.g., step (309) in some embodiments).

Step (303) checks whether cached information was found and if there is enough space in the cached region (or thread-local allocation buffer).

Step (304) selects a region with space associated with the cluster. Step (305) checks if a region with enough space was found. If not, then execution continues to (306) to associate a fresh region with the cluster(s). In many embodiments it would allocate a new empty region from a freelist (or by allocating more memory), and make it the selected region for the cluster in (307). One possibility for reducing lock contention is to release locks before (306) and to restart from (302) with new allocation information for the cluster added to the cache after (306).

Step (308) initializes new allocation information for the selected region. This step might, e.g., allocate a new thread-local allocation buffer from the region, or initialize a NEW pointer for the region.

Step (309) stores the new or updated allocation information in the cache for the cluster(s). There may be a need to make this operation atomic with (302) and (303); known alternatives include the use of a lock or semaphore, the use of software transactional memory, and testing whether the information used in (302) and/or (303) has changed by using an n-CAS (n-way compare and swap) instruction at (309) and restarting from (302) if it has (other opportunistic concurrency control variants can also be used).

Step (310) allocates space for the object from the region implied by the cached information. If a thread-local allocation buffer is used, then this just allocates from the LAB (the LAB implies the region where its allocated data area resides).

In embodiments that use grouped allocation, the cached allocation information could be a group associated with the cluster. (303) could check if the group has grown too big, and (304) to (308) could be replaced by flushing the group (allocating space for all objects in the group, copying the objects into the allocated space, and initializing a new group).

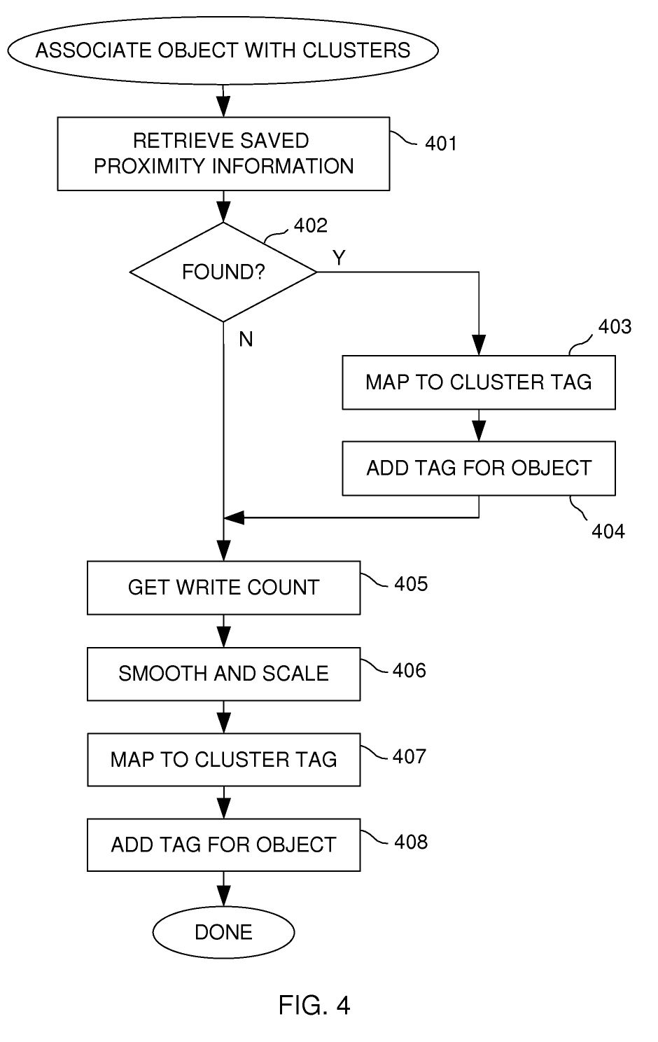

FIG. 4 illustrates associating an object with one or more cluster tags in one possible embodiment. Steps (401) to (404) illustrate determining a tag based on proximity to cluster heads or certain roots. Steps (405) to (408) illustrate assigning a cluster tag based on the write count of the object (it could be any writes, or graph structure modifying writes, i.e., writes to pointer fields). These two tagging approaches are just illustrative; any particular embodiment might contain any number of different tag assignment mechanisms. Based on these, one skilled in the art should be able to construct similar tag assignment methods, program sequences, state machines, or other suitable devices to implement tag assignment for the other measures mentioned herein.

In practice, however, associating an object with tags should be extremely fast, and thus the method of mapping one or more measures to one or more cluster tags is likely to be quite simple in most environments. Useful examples include combinations of taking a logarithm, multiplying by a floating point value, rounding to integer, and looking up from an array.

(401) illustrates retrieving saved proximity information for the object (this information could also be collected while traversing the object graph in the region, starting, e.g., from information saved in remembered sets). In many cases only approximate information is available. (402) checks if saved proximity information was available for the object. If so, (403) maps the object to a cluster tag, e.g., by selecting the “nearest” cluster according to the available proximity information. (404) adds the selected tag for the object (e.g., by setting a bit in a bitmap, or adding it to a list, set or bag of tags for the current object, or assigning a variable indicating the only primary tag for the object).

(405) obtains the write count for the object. For example, the system might maintain a cache (e.g., LRU cache) containing a number of objects that have been recently written a number of times. It could collect statistics on writes to such objects in the cache for a period of time, and this step could access the information. In multiobject-based garbage collection, the multiobject descriptor (entry) might contain fields that can be used to obtain this information. In yet other embodiments the information might be estimated per-region or per sub-region at some suitable granularity. In some embodiments, objects belonging to certain classes could have extra fields in the object for tracking such information.

(406) illustrates processing performed on the write count (or other measure). This could include smoothing (e.g., using a FIR or IIR filter over a number of samples), averaging over time (exponentially, geometrically, or arithmetically), scaling (whether linear or non-linear), etc. Many measures could also be combined at this step into a real or discrete valued feature vector. Some measures may not need any preprocessing.

(407) maps the preprocessed feature vector (or single measure) into a cluster tag. This could utilize any suitable method for the mapping, including supervised and unsupervised clustering and classification methods. Basically any known method for mapping a feature value (or vector) to a discrete label or integer value could be used.

(408) adds the chosen tag to the object.

The polarity of relatedness metrics could be reversed, and thus “highest” in that context should be interpreted as the value that indicates “most related”. The same applies to orders.

It may be desirable in some embodiments to augment the method used by the garbage collector for selecting objects for the collection set to take into account the need for reclustering objects in a region. This could be implemented, e.g., by adding or multiplying a “bias” to gc_index (priority of collecting a region), where the bias would be computed from measures related to clustering or changes in their values. The bias could also be based on a “stress” metric, such as the degree to which objects in the region are frequently written by different nodes in a distributed system.

Many variations of the above described embodiments will be available to one skilled in the art without deviating from the essence of the invention as set out herein and in the claims. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

It is to be understood that the aspects and embodiments of the invention described herein may be used in any combination with each other. Several of the aspects and embodiments may be combined together to form a further embodiment of the invention. A method, a computer, or a computer program product which is an aspect of the invention may comprise any number of the embodiments or elements of the invention described herein.

A computer is defined as any data processing device, including but not limited to general purpose computers, embedded computers, special purpose computers, workstations, servers, computer clusters, distributed computers, virtual machines, laptops, handheld devices, wearable computers, and computers designed to be implanted within humans or animals. The various aspects and elements of the present invention may be implemented in a computer in hardware, software, or both.

A computer program product is defined as a computer executable program stored in a computer readable tangible media. The media could be, e.g., semiconductor memory (such as RAM, ROM, or flash memory), optical memory (such as optical disks or crystals), or magnetic memory (such as floppies or hard disks). The media need not necessarily be physically co-located with a computer using it, as the computer could access it via a network or I/O subsystem. A processor in the computer may access the media using any suitable protocol, such as ATA, SATA, SCSI, iSCSI, CFS, NFS, TFTP, FTP, HTTP, RTP, or TCP/IP.

What is claimed is:

1. A method of clustering related objects in a computer comprising a region-based garbage collector, the method comprising:
associating an object with at least one cluster; and
allocating, by the garbage collector, space for the object from a region associated with at least one of the clusters.

2. The method of claim 1, further comprising
caching allocation information referencing a region for at least one of the clusters, and
using the cached allocation information to select the same region for allocating space for a second object associated with the same cluster.

3. The method of claim 2, wherein:
a global cache is used for caching at least a portion of the cached allocation information;
the global cache is used by more than one thread;
the cache is arranged such that allocation information can in the common case be read from the cache without using atomic operations; and
one or more atomic operations are used to update the cache in response to associating a fresh region with a cluster.

4. The method of claim 2, wherein:
the allocating comprises allocating an allocation buffer (LAB) referencing the region associated with the cluster for at least one thread; and
the caching comprises caching the thread-local allocation buffer in a cache local to the thread.

5. The method of claim 2, further characterized by keeping allocation information for at least one cluster cached across more than one evacuation pause.

6. The method of claim 2, further comprising removing allocation information referencing a region from the cache in response to including the region in a collection set.

7. The method of claim 2, further comprising preventing the inclusion of a region in a collection set in response to cached allocation information referencing it.

8. The method of claim 1, further comprising:
collecting more than one object associated with at least one cluster into a group; and
allocating space for all objects in the group from one or more regions associated with at least one of the clusters associated with the objects in the group.

9. The method of claim 8, wherein at least one group is thread-local.

10. The method of claim 1, wherein at least one object is the root of a tree of objects comprising at least two objects, and non-root objects in the tree are allocated from the same region as the root without selecting a region for them separately.

11. The method of claim 1, wherein at least one object is the root of a multiobject, and the entire multiobject is associated and allocated as one unit.

12. The method of claim 1, further comprising associating a fresh region with at least one of the clusters associated with the object.

13. The method of claim 1, wherein said associating an object with at least one cluster comprises computing cluster tags for the object.

14. The method of claim 13, wherein at least one tag is at least partially computed from a measure selected from the group consisting of:
the object's proximity to a cluster head;
the object's reachability from garbage collection roots;
the return addresses contained in the call stack when the object is created;
the frequency of use of the object;
the home node of the object in a distributed system;
the persistence of the object;
the frequency of writes to the object;
the frequency of object graph modifying writes to the object;
the class of the object;
the clusters associated with objects that reference the object;
the age of the object as measured in bytes allocated since the object was created;
the age of the object as measured in the number of times the object has been promoted; and
the age of the object as measured in wall clock time.

15. The method of claim 13, wherein one of the tags computed for the object is selected as the primary tag.

16. The method of claim 13, further comprising storing allocation information in an array indexed by one or more cluster tags.

17. The method of claim 13, wherein at least one cluster tag associated with the object is computed by quantizing a value computed at least partially from at least one measure selected from the group consisting of:
the object's proximity to a cluster head;
the object's reachability from garbage collection roots;
the return addresses contained in the call stack when the object is created;
the frequency of use of the object;
the home node of the object in a distributed system;
the persistence of the object;
the frequency of writes to the object;
the frequency of object graph modifying writes to the object;
the class of the object;
the clusters associated with objects that reference the object;
the age of the object as measured in bytes allocated since the object was created;
the age of the object as measured in the number of times the object has been promoted; and
the age of the object as measured in wall clock time.

18. The method of claim 1, wherein associating an object with at least one cluster comprises computing a relatedness metric at least partially based on one or more measures between the object and at least one candidate cluster, and associating the object with the candidate cluster with which it has the highest computed relatedness metric.

19. The method of claim 18, wherein at least one of the measures is selected from the group consisting of:
the object's proximity to a cluster head;
the object's reachability from garbage collection roots;
the return addresses contained in the call stack when the object is created;
the frequency of use of the object;
the home node of the object in a distributed system;
the persistence of the object;
the frequency of writes to the object;
the frequency of object graph modifying writes to the object;
the class of the object;
the clusters associated with objects that reference the object;
the age of the object as measured in bytes allocated since the object was created;
the age of the object as measured in the number of times the object has been promoted; and
the age of the object as measured in wall clock time.

20. The method of claim 1, further comprising selecting one or more regions for a collection set such that the selection is responsive to the need for reclustering objects in at least one region.

21. The method of claim 1, wherein at least part of the cluster selection is performed by a process running as a mutator.

22. A computer comprising:
a cluster selector; and
a region-based garbage collector comprising a cluster allocator.

23. The computer of claim 22, wherein the cluster selector comprises a relatedness determinator.

24. The computer of claim 22, wherein the cluster selector comprises a tagger.

25. The computer of claim 22, wherein the cluster allocator comprises an allocation information cache.

26. The computer of claim 25, wherein the cache is at least partially thread-local.

27. The computer of claim 22, wherein the cluster allocator comprises a grouped allocator.

28. A computer program product operable to cause a computer to:
associate an object with at least one cluster; and
use a region-based garbage collector to allocate space for the object from a region associated with at least one of the clusters.

29. The computer program product of claim 28, further operable to cause a computer to:
cache allocation information referencing a region for at least one cluster; and
use the cached allocation information to select the same region for allocating space for a second object associated with the same cluster.
